(19) United States
(12) Patent Application Publication
(10) Pub. No.: US 2006/0154054 A1
(43) Pub. Date: Jul. 13, 2006

(54) A FLUSHABLE BODY FLUID ABSORBENT COMPOSITE

(76) Inventors: John Banks, Vancouver (CA); Michael Ong, North Vancouver (CA)

Correspondence Address: VERMETTE & CO., BOX 40, GRANVILLE SQUARE, SUITE 230 - 200 GRANVILLE STREET, VANCOUVER, BC, V6C 1S4, CA

(21) Appl. No.: 10/905,636

(22) Filed: Jan. 13, 2005

(51) Int. Cl. B32B 27/14; B32B 7/12; B32B 15/04; B32B 23/04

(52) U.S. Cl. 428/343; 428/196; 428/195.1; 428/201; 428/351; 428/354; 428/533; 428/537.5

(57) ABSTRACT

A flushable bodily liquid absorbent composite product, having a bodily liquid absorbent core and a backing layer applied to a garment side of the core. The backing layer is readily soluble in cold water and has a water impervious layer on its core side and a water resistant layer on its garment facing side.

### FIELD

The present invention relates to body fluid absorbent composite products such as women's undergarments, wound dressings, breast pads, adults incontinence pouches, ostomy bags pet care products, training pads, doggy diapers and sanitary napkins.

### BACKGROUND

Disposal of plastic infant diapers, and bodily fluid absorbent products in land-fill sites is no longer a long term viable option. Often such materials constitute a biohazard risk and their disposal requires a minimum risk of human contact. Biodegrading these products first rather than allowing them to stay in their current form would be particularly beneficial to the environment.

One option that has been previously addressed in a number of patents has been the development of a composite product that can disperse in the sewerage system. Such products often rely on biodegradation of the barrier layer to disperse and, because of the time required to biodegrade, their disposal in waste water risks clogging of the sewerage system.

U.S. Pat. No. 6,217,562 issued to Brown et al. discloses a water-dispersible disposable enclosure such as an ostomy pouch which raises the temperature of the water that comes into contact with the pouch to a level at which the material melts, dissolves or otherwise disperses. This temperature elevation is accomplished by a water-activated exothermic reagent such as silica gel, aluminum chloride or calcium chloride. The water activated exothermic reagent is applied to the ostomy pouch by means of an external coating.

British Patent Application No. GB 2,295,553 discloses a bodily liquid absorbent core and a backing layer, which is applied to at least one face of the core. The backing layer is rapidly soluble in cold water but insoluble in viscous low volume bodily liquid discharges including menstrual fluid, blood and breast milk.

A layer, which is water soluble, covered by a water insoluble coating forms the backing layer, which is designed to prevent body fluids from escaping into the garment area. When the composite product is deposited in wastewater, the backing layer is exposed on its unprotected side and rapidly disperses in the water. One problem is that the backing layer is unprotected from penetration and degradation due to moisture from the garment side. Humidity at that location can be as high as 100% with temperatures up to 37° C.

Accordingly, it is an object of the invention to provide a composite product that can disperse rapidly in waste water and yet can be resistant to not only body fluids on the body side of the composite product but can also be resistant to moisture on the garment side. It is a further object to provide such a composite product, which is inexpensive.

### SUMMARY OF THE INVENTION

According to the invention there is provided a flushable bodily liquid absorbent composite product, having a bodily liquid absorbent core and a backing layer applied to a garment side of said core. The backing layer is readily soluble in cold water and has a water impervious layer on its core side and a water resistant layer on its garment facing side.

The backing layer is polyvinyl alcohol hydrolyzed to a range of 71 to 99.4%.

Alternatively, the backing layer may be polyvinyl alcohol hydrolyzed to a range of 71 to 89%.

The backing layer is made up of a first layer of polyvinyl acetate co-polymer bead of sufficient thickness to make it water impervious, a second layer of water soluble polyvinyl alcohol, a third layer of polyvinyl acetate co-polymer bead of sufficient thickness to make it water resistant.

The second layer may have a thickness of 20 to 35 microns while the first layer may have a density of 5.6 grams per square meter (gsm). The third layer preferably has a density of 0.032 gsm to 4.8 gsm.

A specific pattern of positioning glue may be applied to the garment facing, backing layer where the glue has a lateral and attachment strength sufficiently high to hold the composite product together. The pattern required is a single block of approximately 45 mm wide and almost as long as the product that it is to hold in place.

This same pattern of glue can be applied to so called ‘blood resistant’ or ‘moisture resistant’ polyvinyl alcohol films to eliminate the risk of positioning glue delamination. When exposed to blood or other moisture the film surface tension of these kinds of polyvinyl alcohol film changes, causing the positioning glue to separate or delaminate from the polyvinyl alcohol film and remain on the garment. Applying a pattern of positioning glue, that has good lateral strength and good adhesion to low surface tension surfaces such as polyvinyl alcohol, and is approximately 45 mm wide and approximately 65% of the length of the product (e.g. 165 mm for a 245 mm sanitary pad) eliminates this risk.

An array of super absorbent polymer coatings, such as polyacrylamide, may be used to cover the backing sheet. The coating is of sufficient thickness and density to absorb moisture on the garment side of the product and thereby lower the moisture level, while still allowing the polyvinyl alcohol film to retain its water soluble characteristics.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a cross-sectional view of the composite product; and

FIG. 2 is a cross-sectional view of an alternative product.

### DETAILED DESCRIPTION WITH REFERENCE TO THE DRAWINGS

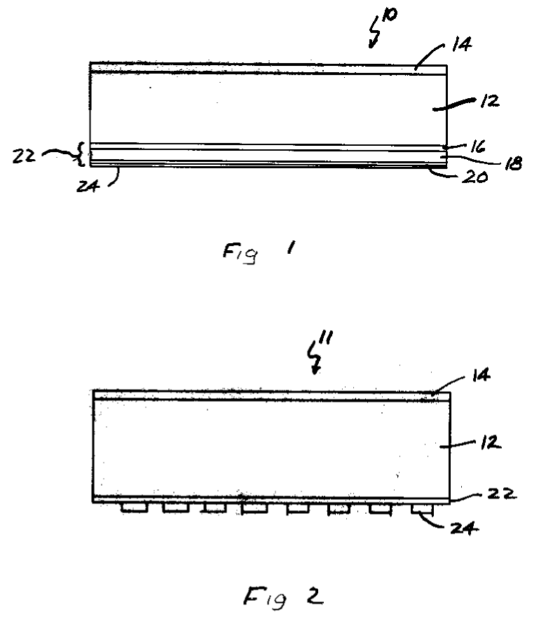

Referring to FIG. 1, the composite product 10 consists of a core 12 of absorbent material such as paper and carboxymethylcellulose. The absorbent pad of material 12 is covered by a coverstock web 14 on its body contacting side and a backing layer 22 on its garment facing side. The coverstock web 14 is made of a biodegradable material, such as rayon or viscose so that it biodegrades after disposal. The backing layer 22 is made of three layers 16, 18, and 20. The first layer 16 next to the core is made 5.6 gsm of polyvinyl acetate (PVA) polymer bead. One source of the PVA polymer bead is McGean Specialty Chemicals Group of Cleveland, Ohio. The bead is applied by a flexographic printer as a solid solution in solvent. Upon evaporation of the solvent, a water impervious layer is formed. Usually two applications are required as the first develops pinholes that compromise the integrity of the film.

The second layer 18 is polyvinyl alcohol and is partially hydrolyzed to a range of 71 to 89% in order to make it cold water soluble. A PVA film with a hydrolization of 98.5 to 99.4% is fully hydrolyzed. Hydrolization in the range of 71 to 99.4% would work but a lower hydrolization ensures a more rapid dissolution in water. The polyvinyl alcohol film may be cast or extruded to a thickness of between 20 to 35 microns.

The third layer 20, which faces the garment, is also polyvinyl acetate polymer bead in a solvent solution. The weight of film is in the range of 0.032 gsm to 4.8 gsm. The weight in this range depends on the desired water solubility required and the disintegration and dissolution performance characteristics of the underlying polyvinyl alcohol film 18 on to which this is applied. If the polyvinyl alcohol film 18 is more cold water soluble, then a higher weight of polyvinyl acetate is selected. Conversely if polyvinyl alcohol film 18 is more hot water soluble then a polyvinyl acetate weight 20 in the lower part of the range is selected.

Finally, a low surface tension positioning glue 24 can be applied to the polyvinyl alcohol layer (PVOH) 20 as a long strip of ¾ inch wide and length of about 65% of the length of the product (e.g. 165 mm or 6.5 inches in sanitary pads). The glue 24 has a high lateral strength in order to hold the composite product 10 together even if the composite product deteriorates. It is also water impervious and has high adherence strength to the PVOH 20. The glue 24 adheres to the clothing of the user and helps keep the composite product in place. As the PVOH 20 degrades in high humidity and high temperature environments the glue strength is preserved and through its lateral strength holds the product together as the product and glue are pulled away and removed from the consumers garment. For applications such as adult incontinence and feminine hygiene products glue may be used. However, diapers and other applications would not ordinarily use positioning glue.

The time to dissolve the film 18 when dropped into a toilet of cold water is between 10 and 60 seconds.

Referring to FIG. 2, the composite product 11 has the same layering as FIG. 1 except that super absorbent polymer, such as polyacrylamide, is deposited over the backing layer 22 and applied to form an array of dots. The super absorbent polymer absorbs and diverts the moisture to lower the humidity at the region of the backing layer 22 on the garment side and, therefore, slows down the degradation of the backing layer 22 due to high moisture conditions. The super absorbent polymer can obviously be applied in different patterns without affecting its performance. It could also be added to the PVOH as an addition to the acetate, or other material used (i.e., shellac or sodium alginate).

As an alternative to the dotted pattern of superabsorbent polymer, either a solvent or solution based superabsorbent polymer can be added as a coating, as a means of lowering the moisture at the region of the backing layer.

As an alternative to the PVA bead used in layers 16 and 20 a shellac layer may be used. In order to avoid small stress fractures in the shellac when mechanically stressed, a plasticizer in an alcohol solution may be added and a wax coating applied.

As a further alternative, paper could be used for the backing layer coated with shellac or acetate to make the backing layer water impervious from the core side and water resistant from the garment side. The advantage of using paper to replace layer 18 is the low cost of the paper as opposed to the high cost of polyvinyl alcohol. The paper must have sufficient strength to resist tearing when subjected to the stresses caused by movement of a user. Ordinary grade 25 tissue is acceptable for this purpose as would certain synthetic papers.

Yet another alternative is the use of paper coated with polyvinyl alcohol on both sides applied by means of a flexographic printer. Other methods of application may be used.

A further alternative is to add polyvinyl alcohol to the wood pulp during paper production so that the polyvinyl alcohol becomes embedded in the paper. By adding polyvinyl alcohol to the pulp during the production process the manufacture can combine the extensive drying required for both materials at the end of the production process. The inclusion of polyvinyl alcohol in the paper prevents any rustling noise that would otherwise be given off when the consumer wears the product and moves around and again lowers the cost of the film 18 used in the composite product.

While making the backing layer water resistant from the garment side slows down the rate of disintegration of the composite product somewhat, its enhanced resistance to moisture penetration from the garment significantly extends the useful life of the composite product.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

What is claimed is:

1. A flushable bodily liquid absorbent composite product, comprising:
(a) a bodily liquid absorbent core; and
(b) a backing layer applied to a garment side of said core, said backing layer readily soluble in cold water and having a water impervious layer on its core side and a water resistant layer on its garment facing side.

2. The product according to claim 1, wherein said backing layer is polyvinyl alcohol hydrolyzed to a range of 71 to 99.4%.

3. The product according to claim 1, wherein said backing layer is polyvinyl alcohol hydrolyzed to a range of 71 to 89%.

4. The product according to claim 1, wherein said backing layer is made up of a first layer of polyvinyl acetate co-polymer bead of sufficient thickness to make it water impervious, a second layer of water soluble polymer, a third layer of polyvinyl acetate co-polymer bead of sufficient thickness to make it water resistant.

5. The product according to claim 4, wherein second layer has a thickness of 20 to 35 microns.

6. The product according to claim 4, wherein the first layer has a density of 5.66 grams per square meter.

7. The product according to claim 4, wherein the third layer has a density of 0.032 grams per square meter to 4.8 grams per square meter.

8. The product according to claim 1, including a positioning glue applied to said backing layer in a pre-selected pattern having a lateral and attachment strength sufficiently high to hold said composite product together.

9. The product according to claim 1, including a positioning glue applied to an uncoated, blood resistant and moisture resistant polyvinyl alcohol film, so the that the positioning glue will not delaminate and will retain its strength and maintain the integrity of said composite product when removed from the garment.

10. The product according to claim 1, including an array of superabsorbent polymers, such as polyacrylamide, applied in a pattern, each spot of sufficient thickness and density to absorb moisture on a garment side of said product and thereby lower the moisture level.

11. The product according to claim 1, including the application of one of a solvent based and solution based superabsorbent polymer applied as a coating of sufficient thickness to absorb moisture on a garment side of the product and thereby lower the moisture level, applied additionally to the polyvinyl acetate or instead of said polyvinyl acetate.

12. The product according to claim 1, wherein said backing layer is made of paper having sufficient tensile strength to resist tearing in response to ordinary body movements.

13. The product according to claim 1, wherein said backing layer is paper embedded with polyvinyl alcohol.

14. The product according to claim 1, wherein said backing layer is paper coated with polyvinyl alcohol.
